(19) United States
(12) Patent Application Publication
(10) Pub. No.: US 2019/0066010 A1
(43) Pub. Date: Feb. 28, 2019

(54) PREDICTIVE MODEL FOR OPTIMIZING FACILITY USAGE

(71) Applicant: United States of America as Represented by the Secretary of the Army, Alexandria, VA (US)

(72) Inventor: Michael N Grussing, Champaign, IL (US)

(21) Appl. No.: 15/686,102

(22) Filed: Aug. 24, 2017

(51) Int. Cl. G06Q 10/06; G06Q 10/04; G06N 7/00

(52) U.S. Cl. CPC G06Q 10/0635; G06N 7/005; G06Q 10/04

(57) ABSTRACT

This invention provides a system for creating a predictive model of facility reliability. The system includes a Predictive Model Processor that receives condition index values, reliability index values and criticality values associated with a plurality of components of varying type. The Predictive Model Processor also applies a Bayesian Network approach to determine the functional relationships between component-types and generates graphical model for representing dependencies and failure probabilities between said components and associated systems of a facility. The graphic models produced as output may be used to produce Bayesian Network models based on system level risk and reliability.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention relates to the field of computer processing architectures and more specifically to a specialized computer architecture for creating a predictive model of system reliability.

### BACKGROUND OF THE INVENTION

The U.S. Department of Defense (DoD) currently spends more than 15% of its budget on facilities maintenance for the Army, Navy and Air Force. The US Army owns over 165,000 buildings comprising 1.1 billion square feet and billions of individual components. Military facilities which are unreliable due to deferred maintenance issues must be abandoned to mitigate the risk that the “reliability” of the facility might jeopardize military objectives.

BUILDER™ Sustainment Management System (SMS) is a web-based software application developed by the US Army's Engineer Research and Development Center (ERDC) Construction Engineering Research Laboratory (CERL) to provide accurate metrics about the reliability of facilities.

BUILDER™ can receive actual inspection records for billions of components and improves statistical accuracy of predictive modeling for deterioration. As taught in U.S. application Ser. No. 15/674,321, BUILDER™ assigns a Condition Index (CI) value to each component based on actual inspection data. BUILDER™ also uses a measurement called the Facility Condition Index (FCI) to compare the cost of repairing a facility to a like-new condition versus the cost of fully replacing that facility.

The FCI was designed primarily as a budgetary tool and was not designed to offer engineering system insight.

Consider an example of a facility with two components C1 and C2 with reliability index values of 0.2 and 0.8 respectively and 0.75 criticality index values of 0.75 and 0.25. The reliability index of the system is calculated based on the weighted average of the criticality values as follows: (0.75*0.2+0.25*0.8)/(0.75+0.25)=0.35.

Using this equation, if components C1 and C2 have criticality values of 0.1, indicating that neither component has a high probability of interrupting system function or performance, the reliability index is 0.5.

Alternatively assume that both criticality values are e 0.9, indicating a high probability of system interruption if either component fails. The weighted average approach still yields a system reliability index of 0.5.

The FCI index does not accurately depict the higher risk of failure of the components in the latter scenario.

There is an unmet need for computational systems which enable the Army, Navy and Air Force to properly evaluate, prioritize and optimize the management of components of geographically dispersed facilities.

There is a further unmet need for computational systems and predictive modeling tools which can be used to assess system reliability and risk of failure while accurately accounting for complex system dependencies.

### BRIEF SUMMARY OF THE INVENTION

The invention is a system for a creating a predictive model of system reliability. The system includes a Predictive Model Processor that receives condition index values and reliability index values from a Condition Database and Reliability Database respectively for a plurality of components. The Predictive Model Processor further receives criticality values and relationship values from a Criticality Database and Relationship Database respectively.

The Predictive Model Processor identifies one or more relationships between said plurality of component-types and assigns a relationship value to each of said plurality of component-types. Moreover, the Predictive Model Processor uses a Bayesian Network approach to generate a graphical model of components and their dependencies within a system.

### BRIEF DESCRIPTION OF THE DRAWINGS

FIG. 1 illustrates an exemplary System 100 for creating a predictive model of facility reliability.

FIG. 2 illustrates an exemplary Method 200 for creating a predictive model of facility reliability.

FIG. 3 illustrates a table of exemplary condition index values used to assess the condition of a component.

FIG. 4 illustrates an exemplary data structure for performing functions to associate component-types with condition index values and reliability index values.

FIGS. 5a, 5b and 5c illustrate exemplary component criticality matrices of varying type.

FIG. 6 illustrates an exemplary data structure for depicting the relationship among components types based on assigned criticality values.

FIG. 7 illustrates an exemplary component interaction and system diagram for a facility.

FIGS. 8a, 8b, and 8c illustrate an exemplary graphical interface for representing relationships between components for predicting system failure.

FIG. 9 is an exemplary data structure for modeling relationships between components for predicting system failure.

### TERMS OF ART

As used herein, the term “adjusted system reliability” means a measure of the total system and facility level reliability

As used herein, the term “Bayesian Network” means a probabilistic graphical model that represents a set of random variables and their conditional dependencies.

As used herein, the term “component-type” means a model of a type of component based on actual data derived from inspection of a plurality of components in service.

As used herein, the term “computer architecture” means an integrated set of processing components which define the specialized functionality of a computer apparatus or network. Computer architecture may refer hardware components, servers, data structures, class and object definitions, virtualized components and/or components stored in memory which are non-modifiable at run time to emulate physical hardware components and combinations thereof.

As used herein, the term “condition index (Cl) value” means a value for indicating a condition deterioration of a component as observed at a specific time interval.

As used herein, the term “criticality value” means a value associated with a component which represents the level of risk (or risk relative to other components) of system failure if that particular component were to fail.

As used herein, the term “data structure” is any data in any format which can be stored in computer and which may include non-modifiable attributes and values once created.

As used herein, the term “entity” means any component or system of a. facility having a mechanical dependency.

As used herein, the term “facility” means two or more functionally interrelated systems.

As used herein, the term “interval” means a uniform time interval selected by a user and need not conform to the time to the variable observation interval.

As used herein, the term “mechanical dependencies” means relationships whereby the failure of one component-type results in a higher probability that another will fail.

As used herein, the term “predictive model” means a digital representation of an entity or phenomena which includes that which may be updated in real time.

As used herein, the term “processor” means hardware or software having processing capability which may be bound to non-modifiable values and functions.

As used herein, the term “relationship value” means a value for identifying or representing relationships between components and/or systems.

As used herein, the term “reliability index (RI) value” means a value representing reliability and/or risk of failure of a component.

As used herein, the term “system reliability” means a value for indicating the reliability of the system based on the use of one or more components.

As used herein, the term “system failure” means probability of failure of a system or due to failure of a component.

As used herein, the term “system-type” means a type of system or sub-system thereof.

As used herein, the term “virtual processing component” refers to software which performs a computational process and functions identically to the circuitry of a physical processor.

### DETAILED DESCRIPTION OF THE INVENTION

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention. Moreover, the terms “about,” “substantially” or “approximately” as used herein may be applied to modify any quantitative representation that could permissibly vary without resulting in a change in the basic function to which it is related.

The following description of exemplary embodiments of a [invention] shall be interpreted with reference to U.S. Supreme Court standards pertaining to computer implemented inventions. Functional processing components may be described in terms of hardware or software processing (“virtual”) components. The term “apparatus” may refer to one or multiple devices and may contain virtual components functionally integrated with hardware to perform novel or specialized processing functions. Furthermore, various types of virtual components may be referred to as “classes” or “objects,” however.this designation shall not be construed as language or platform specific. A class, object or virtual component may refer to any aggregation of functions and data types which may be functionally bound to a microprocessor to form a specific purpose computer with novel and identifiable capabilities.

The terms “a” and “an” may refer to a single or multiple elements of the same type and shall be interpreted as “at least one.” The term “plurality” shall mean two or more. Steps may be performed in any order and shall be construed to encompass any function, formula, process or transformative action.

References to data types and data sets (e.g. attributes, parameters and variables) shall be interpreted as data sets derived through experimentation to yield specific or unexpected results. Tables may be identified as representing data structures, arrays or the like.

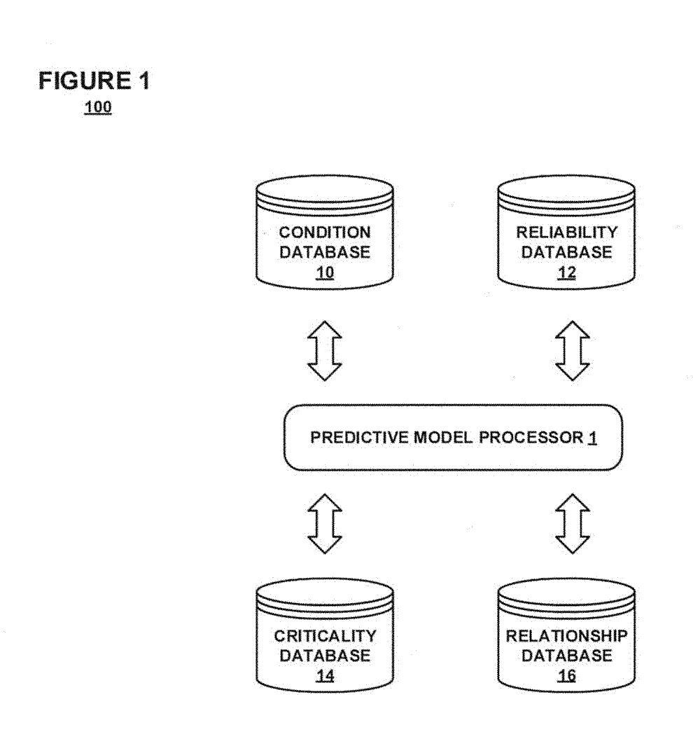

FIG. 1 illustrates an exemplary System 100 for creating a predictive model of system reliability. The exemplary embodiment shown includes a Condition Database 10, a Reliability Database 12, a Criticality Database 14, a Relationship Database 16 and a Predictive Model Processor 1.

In the exemplary embodiment shown, the Condition Database 10 is comprised of component-types associated with condition index (CI) values, wherein said CI is a value which represents a condition of each of the said component-types. Each of said condition index values are associated with a time interval.

FIG. 1 further illustrates a Reliability Database 12 is comprised of component-types associated with reliability index (RI) values, wherein said RI is a value which represents a probability said component-types will have a condition index value above a set threshold.

In the exemplary embodiment shown, Criticality Database 14 is comprised of component-types associated with criticality values. The criticality values are selected from a group consisting of a value for representing the effect of said component-types on performance of the system, a value for representing the effect of said component-types on the performance of associated component-types and a value for representing a quality of life of a user of the system.

FIG. 1 further illustrates Relationship Database 16 is comprised of component-types associated with a relationship value, wherein said relationship value represents a relationship between said component-types. In the exemplary embodiment shown, Relationship Database 16 is comprised of component-types associated with a relationship value, wherein said relationship value represents a relationship between system types.

In the exemplary embodiment shown, the Predictive Model Processor 1 receives as input the condition index value and reliability index value for one of said component-types and calculates a system failure probability if one of said component-types were to fail. The Predictive Model Processor 1 is configured to calculate system reliability using a Bayesian Network approach, and produces graphical interfaces that include tables, Bayesian Networks and other logical formats defined by objects which extract data from the various database components of System 100 to update a user interface.

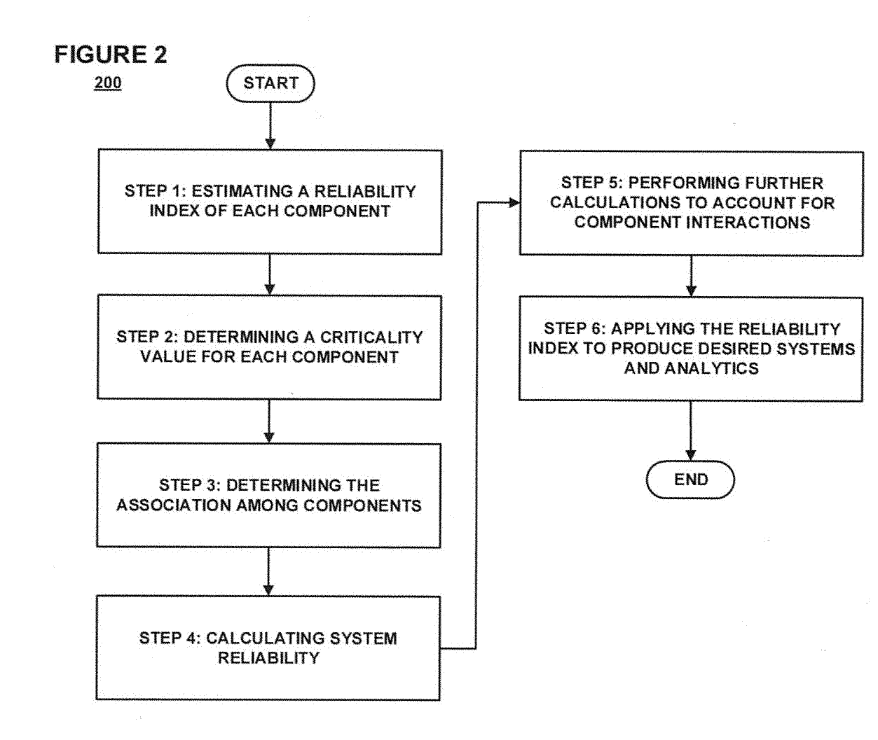

FIG. 2 illustrates an exemplary Method 200 for creating a predictive model of facility reliability. In the exemplary embodiment shown, System 100 requires a computer architecture with at least one virtual processing component, referred to herein as Predictive Model Processor 1, to perform the steps of Method 200.

Step 1 is the step of estimating a reliability of components of a facility based on the reliability index value of a component. This includes accessing the Reliability Database 16 of FIG. 1. The reliability index value is statistically calculated using a probabilistic approach, such as taught by U.S. application Ser. No. 15/674,321, or any other method. In various embodiments, the reliability index values may be associated with condition index (CI) values as maintained in the Condition Database 10. The Predictive Model Processor 1 may perform further calculations to group components into systems.

The exemplary embodiment shown in FIG. 1 utilizes the discrete Markov Chain condition prediction model to calculate the component reliability index value. The Markov Chain model uses a characteristic transition matrix, developed from large datasets of inspection data records, to describe the probability of a building component transitioning from one condition index value to another in a pre-defined period. If the component has previously been observed to have a pre-defined condition index value at the time of the most recent inspection, the characteristic transition matrix describes the condition-based deterioration behavior a component having matching attributes of the component of interest.

Step 2 is the step of determining a criticality value for each component. The Predictive Model Processor 1 analyzes the reliability index value and condition index value of a component to determine which criticality index value to assign to said component. The criticality value may be a score ranging from 0 to 1, with higher values indicating higher criticality of the component to system or facility performance. This rating may vary across different system types given that some components may have a higher criticality (importance) in certain systems or facilities than others.

Step 3 is the step of determining the association among components of a system and/or within a facility. The Predictive Model Processor 1 iteratively extracts and compares component data as well as the criticality index for each system to determine operational dependencies among components on a relational, data processing basis. In certain embodiments, the Relationship Database 16 may include data for indicating said dependencies, including but not limited to, facility diagrams, inventory and system reports, etc.

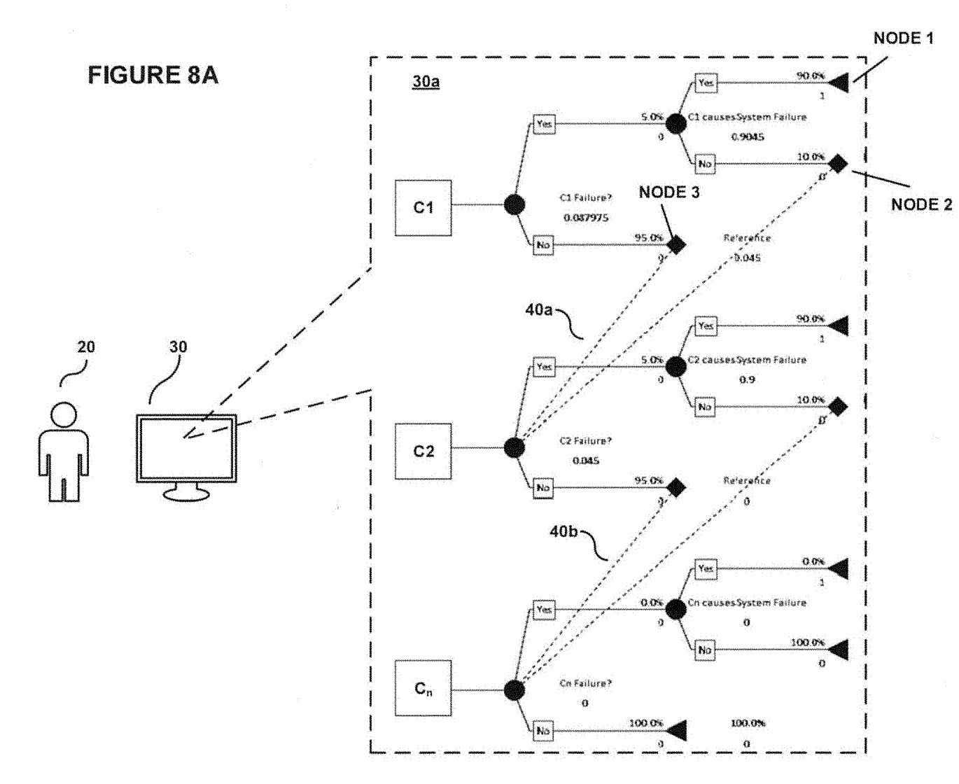

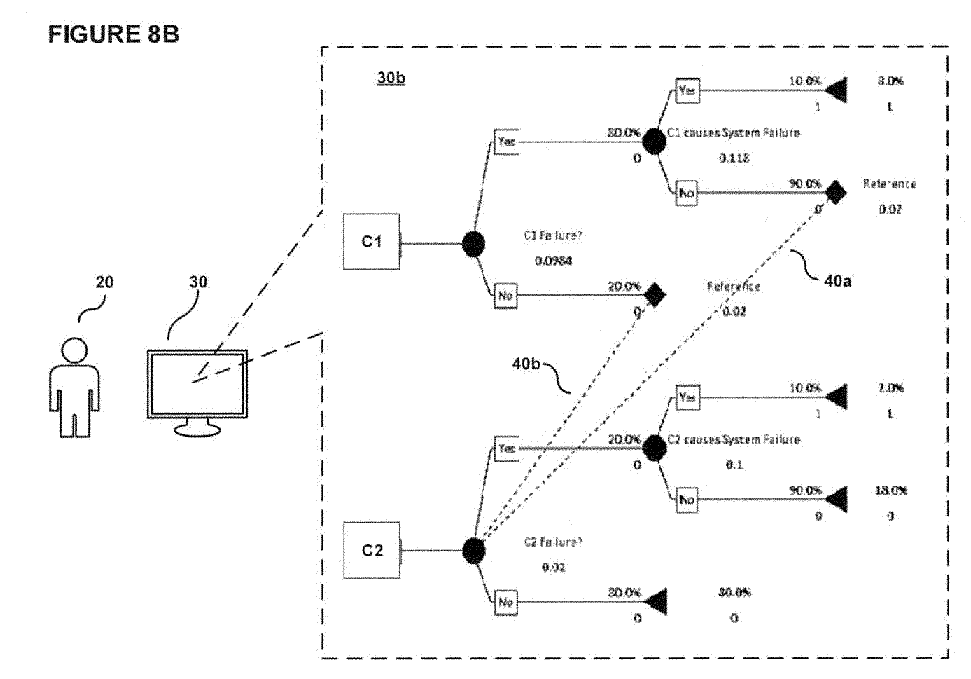

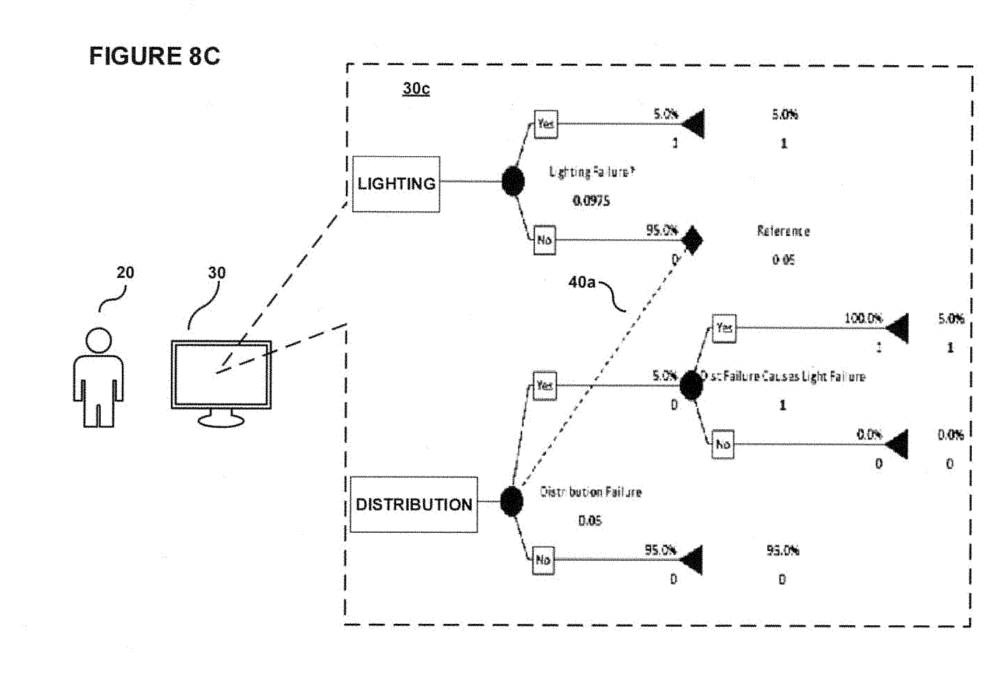

Step 4 is the step of calculating system reliability. The Predictive Model Processor 1 uses a Bayesian Network approach as further described with respect to FIGS. 8A-8C. A Bayesian Network is a probabilistic graphical model that represents a set of random variables and their conditional dependencies, and can be used for system failure diagnosis.

Step 5 is the step of performing further calculations to account for component interactions. This includes the Predictive Model Processor 1 calculating an adjusted reliability index value based on the determined component interactions and relationship values determined per Step 3. In certain embodiments, the Predictive Model Processor 1 aggregates the reliability index values to higher levels to generate an adjusted system reliability. The adjusted system reliability is a system and facility level reliability index value that results in a more accurate picture of performance since component dependencies are accounted for.

Step 6 is the step of applying the reliability index to produce desired systems and analytics. This may include generating a model for predicting system reliability (the probability of system failure) or producing a mathematical table that replicates the component and system dependency calculations for multiple systems, components and interactions.

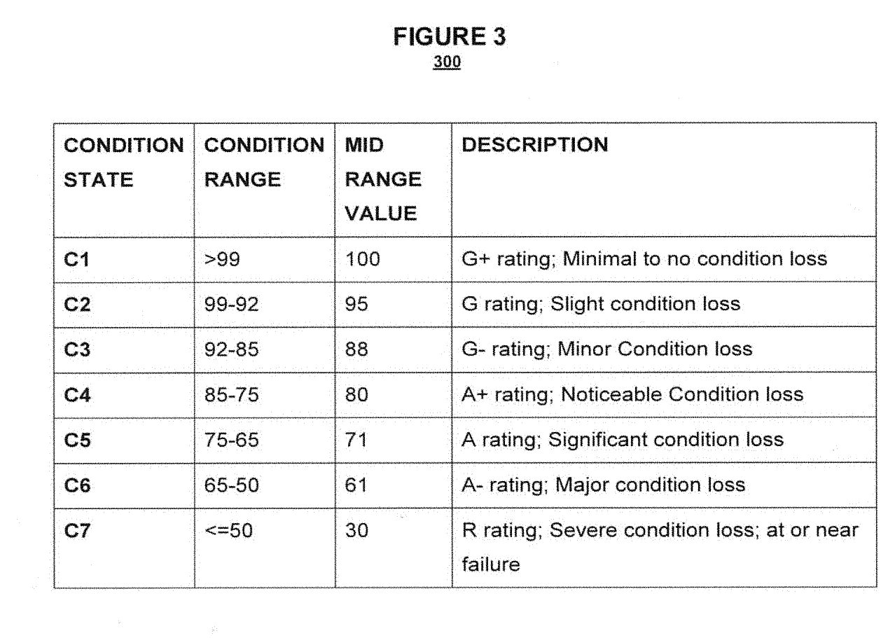

FIG. 3 illustrates a table of exemplary condition index values used to assess the condition of a component. The condition index values are stored in a data structure, which in the exemplary embodiment shown is a table or relational data base 300 as taught by U.S. patent application Ser. No. 15/674,321. The exemplary table shown is developed from a Markov Chain model which uses a characteristic transition matrix, developed from large datasets of condition inspection data, to describe the probability of a building component transitioning from one condition state to another.

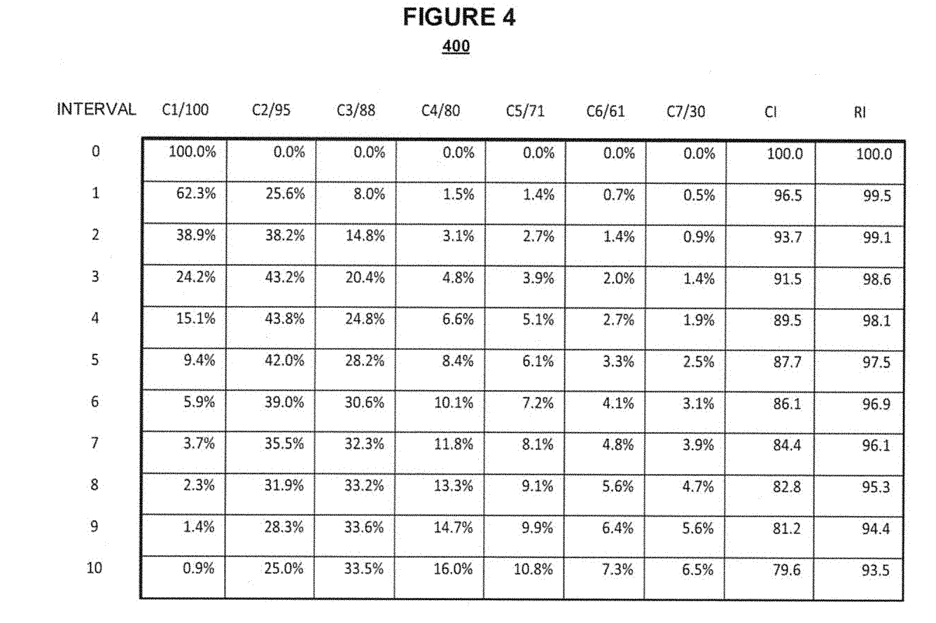

FIG. 4 illustrates an exemplary data structure for performing functions to associate component-types with condition index values and reliability index values.

The exemplary data structure 400 shown comprises condition index (CI) values and reliability index (RI) values calculated as taught by U.S. application Ser. No. 15/674,321. To illustrate, consider a scenario where a component-type of interest is in condition state C1 at the time of its installation. At this point in time, its condition vector is given by C₀=[1 0 0 0 0 0 0 ]. To estimate the condition index value at some point t years past the install year, this is given as:

Cₜ=C₀×M^{t} Equation 1

If an inspection was recently performed, at year tᵢ, and this resulted in condition index value Cᵢ, then current expected condition Cₜ is updated using:

Cₜ=Cᵢ×M^{(t-i)} Equation 2

Cₜ represents the probability of each condition. Assigning each condition state a representative condition index value, as given in column 3 of data structure 300 of FIG. 3, and defining this as vector CIᵥₐₗᵤₑ, one can compute the expected condition index value, CIₜ, at any point in time as:

CIₜ=Cₜ×CIᵥₐₗᵤₑ Equation 3

In addition, the reliability index (RI) value is defined as the probability of the CI value or condition state being above a set threshold limit. Under this scenario, condition state C7 is defined as the threshold limit, which represents a failed condition state. Further, a limit vector L is defined with the value of 0 for any condition state that is a limit state, and a value of 1 for any state that is a non-failed state. For example, if

L=[1 1 1 1 1 0]^{T} Equation 4

Hence, the reliability index, RIₜ, at a point in time can be computed as:

RIₜ=Cₜ×L Equation 5

FIG. 4 correlates CI values and RI values at discrete points in time. Column Cn represents the probability of a component-type being associated with a specific condition index value. In the example, the projected CI at year 5 is: CI(5)=0.094×100+0.42×95+0.282×88+0.084×80+0.061×71+0.033×61+0.025×30=87.7

The associated RI value represents the probability the component is in a non-failed state at a point in time. For the exemplary embodiment shown, in year 5 the calculation for projected RI value is:

RI(5)=0.094+0.42+0.282+0.084+0.061+0.033+0.025=97.5

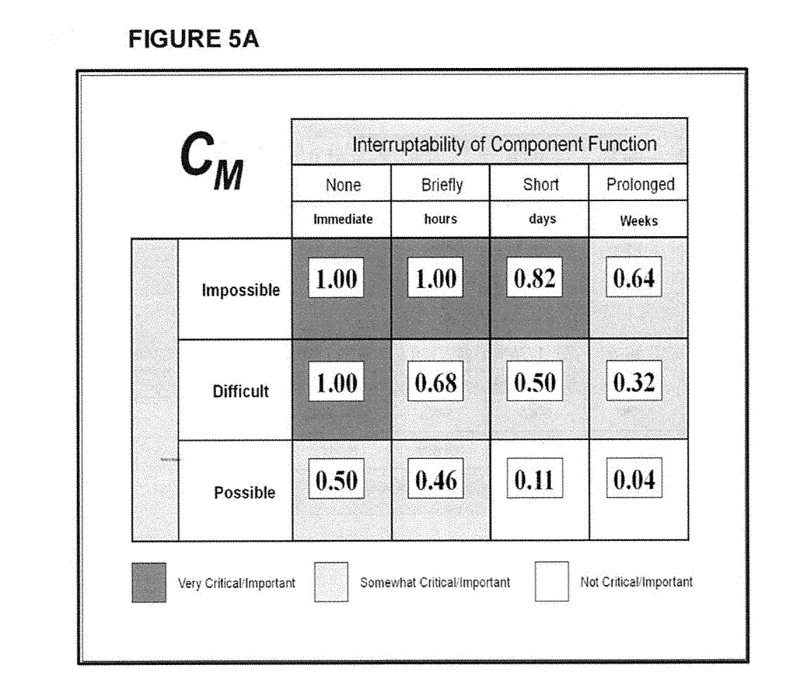

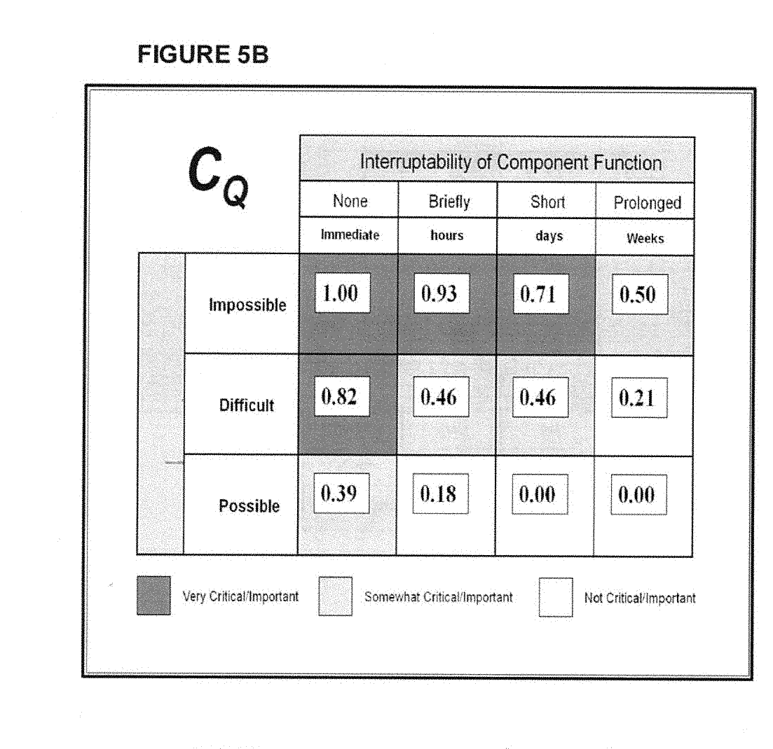

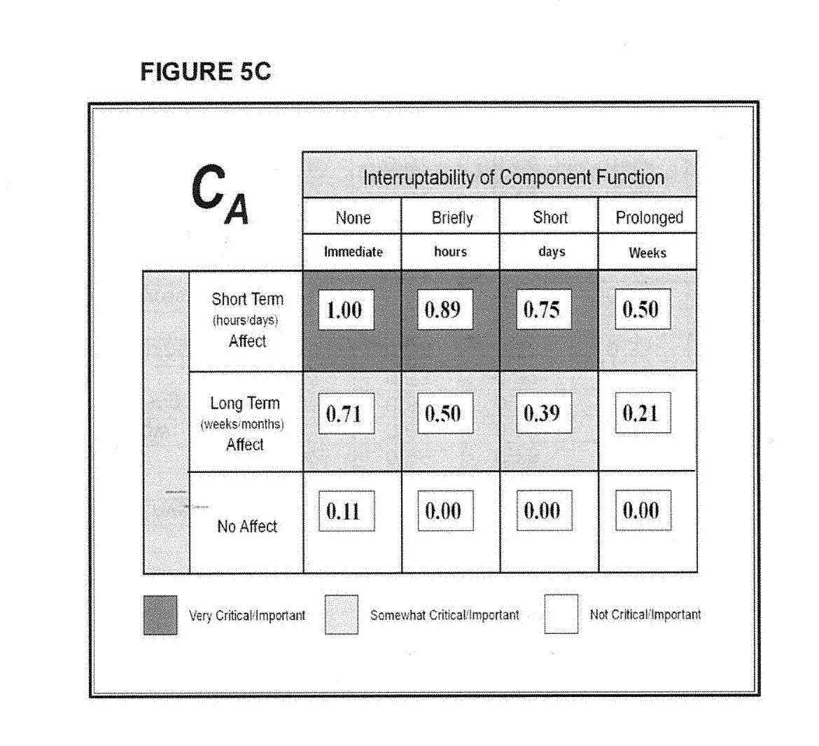

FIGS. 5a, 5b and 5c illustrate exemplary component criticality matrices of varying type. The indices are data structures that can be used to quantitatively estimate and process data regarding the consequence of component failure. For example, if failure of a particular component would affect performance of a facility, this component would be assigned a higher criticality value. FIG. 5a is a criticality matrix for assessing a component's importance for supporting system or facility mission performance. FIG. 5b is a criticality matrix for assessing a component's importance for supporting the quality of life of users of the system or facility. FIG. 5c is a criticality matrix for assessing a component's importance to the operation and function of other components of a system or facility.

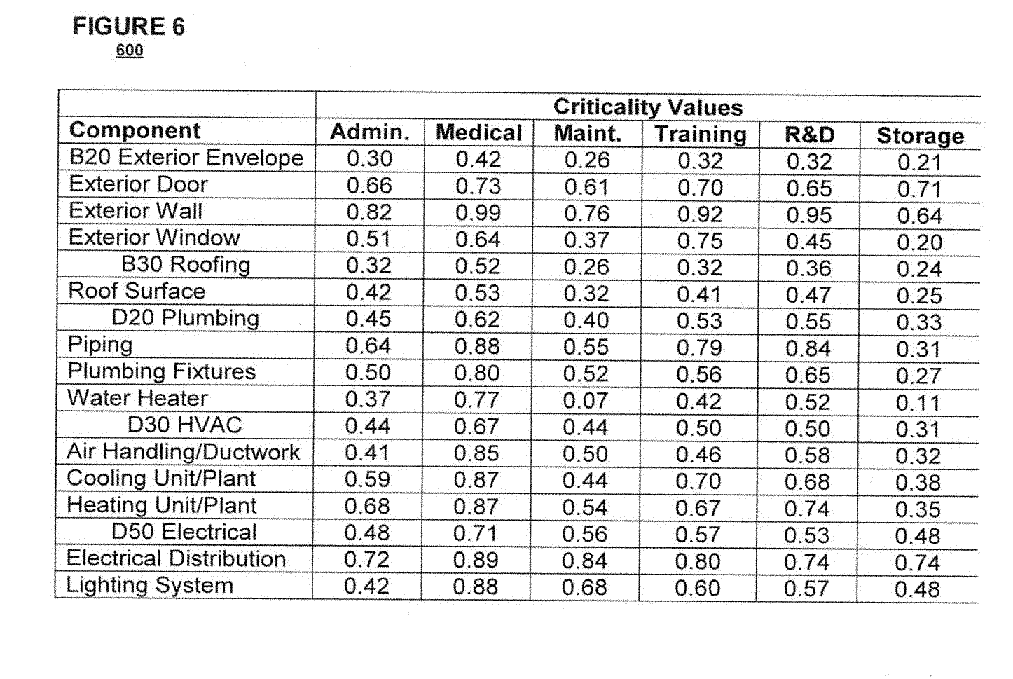

FIG. 6 illustrates an exemplary data structure for depicting the relationship among components types based on assigned criticality values. In the exemplary embodiment shown, the criticality values of data structure 600 are populated by subject matter experts (SMEs) who designate a value to reflect the assumed impact of component interruption as well as immediacy of that impact. In the exemplary embodiment shown, the data reflects a criticality value (rating) associated with various component-types (Column 1) and with types of facilities (Columns 2-7).

In the example, if failure of a particular component for an operational and training building would make mission performance difficult, the adverse effect would transpire within hours of failure. This would result in the component receiving a 0.68 mission criticality value as shown in FIG. 5a. The same evaluation would subsequently be performed by the SMEs to obtain a quality of life (QOL) criticality value per FIG. 5b as well as one for operational and maintenance (O&M) effect value per FIG. 5c. These values are aggregated based on the relative importance of mission, QOL and O&M effects to obtain the overall criticality value for that type of facility and component-type—resulting in tabulation of data structure 600. It is noted this process is similar to the development of the mission dependency indices (Antelman, et al 2008) for determining facility importance to mission.

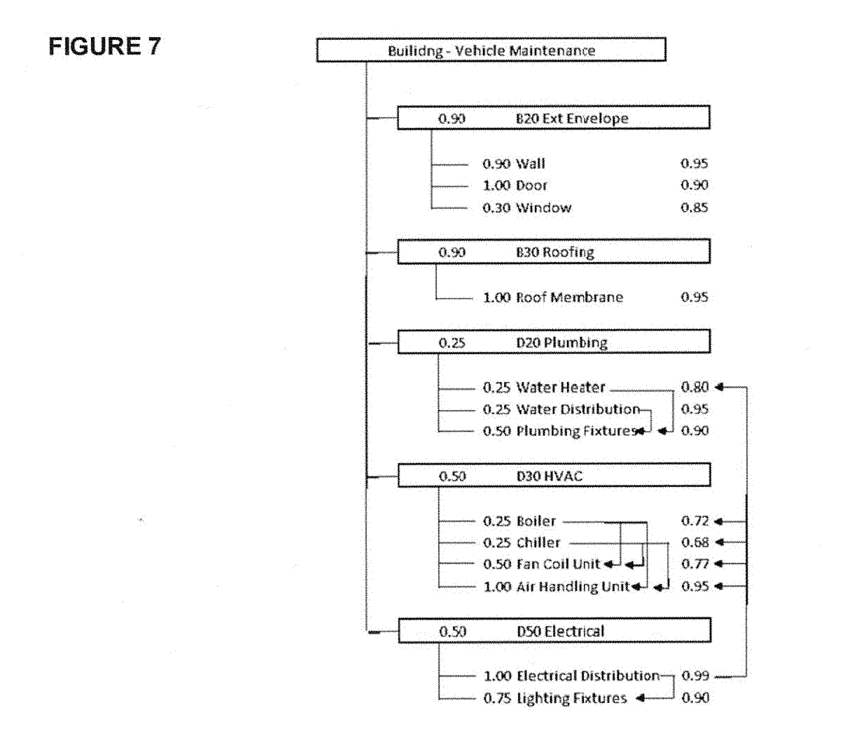

FIG. 7 illustrates an exemplary component interaction and system diagram for a facility. The diagram illustrates an exemplary approach for determining component relationships. Corresponding reliability index values and criticality values for each component and system of the facility are also shown. In this example, arrows are further presented for indicating the operational dependencies among components. Under this scenario, the facility is a vehicle maintenance facility, which includes an electrical system that features an electrical distribution component having a criticality value of 0.99. This represents a 99% probability of failure of other dependent and/or related components within the facility—as shown by the arrows—along with their corresponding criticality values.

FIGS. 8a, 8b and 8c illustrate an exemplary graphical interface for representing relationships between components for predicting system failure. The graphical representations are generated by the Predictive Model Processor 1 based on the processes described herein. In the exemplary embodiments shown, the graphical model output may be rendered to a display device 30 for presentment to a user 20 by way of any known graphical user interface techniques. By way of example, the Predictive Model Processor 1 generates graphical models 30a, 30b and 30c using Bayesian Network analysis. This results in presentment of said graphical models 30a, 30b and 30c with the associated component and system dependencies along with reliability values as depicted in FIG. 7.

A Bayesian Network is a probabilistic graphical model that represents a set of random variables and their conditional dependencies and can be used for system failure diagnosis (e.g., Fenton and Neil 2012). In the case of a facility (building) system, if a system is comprised of n building components, where component Cᵢ has a reliability index value RIᵢ and a criticality value CIIᵢ , the system level reliability can be calculated as follows:

RIₐ=1−Sum [P(Cᵢ caused system failure|Cᵢ₋₁ did not cause system failure)] Equation 6

Graphical models 30a, 30b and 30c of FIGS. 8a, 8b and 8c respectively illustrate the Bayesian approach to modeling. For example, in graphical model 30a of FIG. 8a, the top tree represents the probability of failure as caused by component C1. The second tree represents the probability of system failure caused by component C2 given component C1 did not cause system failure, The third tree represents the probability of system failure caused by component Cn, given all previous components did not cause system failure. Each model tree is joined to the subsequent one by the dotted reference lines, i.e., reference lines 40a and 40b, which transfers the conditional probability of failure to the nodes above to form a network of components. The result is a calculation of system failure if any of the components fail. The complement of this system failure probability is the reliability index for the system, which is based on the reliability index value and criticality factors for each of the components that are part of it.

In FIG. 8b, exemplary components C1 and C2 have reliability indices of 0.2 and 0.8 respectively. Assuming criticality values of 0.1 for both, the system reliability is 0.9016, indicating high system reliability. Assuming component importance at a 0.9 criticality level for both, the system reliability drops to 0.2296. This lower system reliability reflects the higher impact a component failure would cause. The RI value of the component would be maintained at a higher level through repair or replacement activities to ensure an adequate system reliability. For this scenario, if a 0.9 system reliability was established as a minimum threshold, the reliability index for both components (C1 and C2 of FIG. 8b) would need to be maintained at an individual reliability index of 0.95 to meet the goal.

In addition to a component's importance respective to the facility or system it is part of, a component may also directly impact the operation, function, or performance of other components. For example, in FIG. 8c, interior lighting fixtures require electrical power, so if the electrical distribution suffers performance loss due to a faulty panel or transformer, that will affect the reliability of the lights. One can model these component interactions as shown per graphical model 30c, which depicts a decision tree modeling component interaction for a lighting component and distribution component.

As noted previously, the Predictive Model Processor 1 may generate an adjusted system reliability to reflect reliability in terms of all components and their dependences. For example, if component Ca is dependent on components Cₓ, C_{y} and C_{z} to function, the adjusted system reliability (reliability index adjusted (RIA)), of component Ca is given by:

RIAₐ=1−(((((1−RIₐ)×RIAₓ)+(1−RIAₓ))×RIA_{y}+(1−RIA_{y}))×RIA_{z} (1−RIA_{z})) Equation 7

This feature of the System 100 allows a user 20 to adjust the observed reliability of a component based on its condition information to account for the associated reliability of other components for which it depends on for operation. This adjusted effective reliability is then used to aggregate the reliability index to a system and building level, resulting in a more accurate picture of system performance (since component dependencies are accounted for).

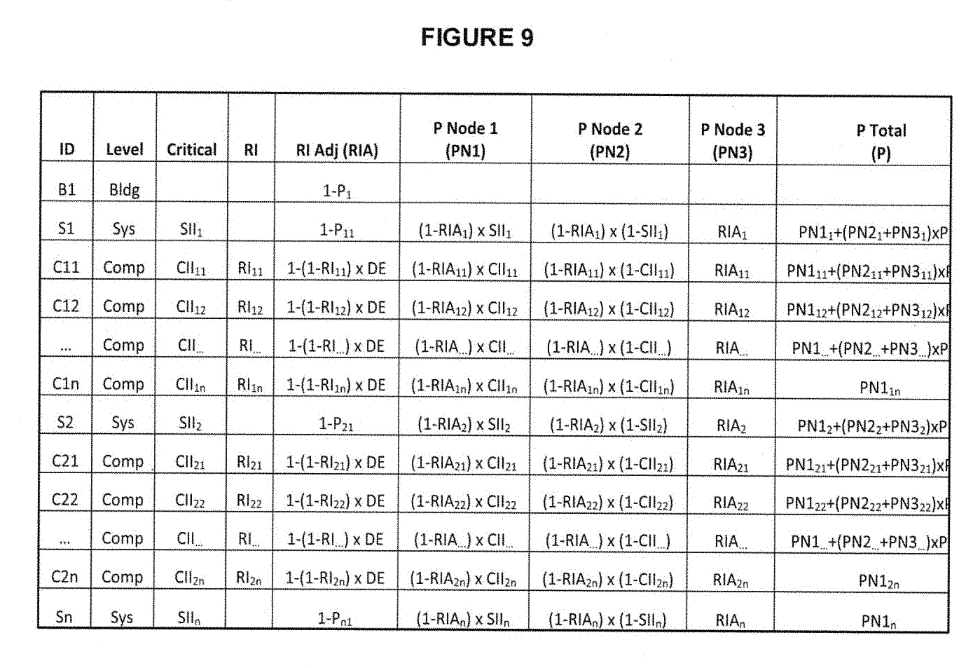

FIG. 9 is an exemplary data structure for modeling relationships between components for predicting system failure. The exemplary data structure illustrated replicates the calculations described above across multiple systems, components and interactions.

In the exemplary data structure shown, each component is grouped into a system. Each component has a criticality value and a reliability index value that is based on the most recent inspection data records. Based on these values, the probabilities for Nodes 1-3 in the Bayesian Network tree (labeled as NODES 1-3 per FIG. 8a) can be calculated for each component. The total probability of component i causing a system failure, given component i−1 did not cause failure, is calculated in the last column, which is aggregated up from the last component in each system up to the first component in each system, which is then used to calculate the system reliability. Once all the system reliability across components/systems have been calculated, the respective values are aggregated to the facility level using the same process. If a component's operation is dependent on another component's reliability index value, Equation 7 above can be used to adjust the RI value of the component based on this new information. While the component RI value is the received as input by the data structure, the adjusted RI is used to calculate the total system and building level reliability.

It will be appreciated by those skilled in the art that the above described analysis and corresponding graphical models 30a, 30b and 30c rendered by System 100 as output may be used to allocate, manage and prioritize work activities and resources based on component and system level risk and reliability. Furthermore, the System 100 may be integrated for use with a Computer-Aided Facility Management (CAFM) tool or other diagnostic tool for supporting large scale facility and system maintenance and performance optimization.

What is claimed is:

1. A system for creating a predictive model of facility reliability, comprised of:
a Condition Database which stores and associates condition index values with component-types;
Reliability Database which stares and associates reliability index valines with component-types;
Criticality Database which stores and associates criticality values with component-types;
a Relationship Database; and
a Predictive Model Processor which extracts data from said Condition Database, said Reliability Database, said Criticality Database and said Relationship Database to create a predictive model of the reliability of a facility reflecting mechanical dependencies.

2. The system of claim 1 wherein each of said mechanical dependencies are relationships whereby the failure of one entity results in a higher probability that another will fail.

3. The system of claim 1 which further includes stored values reflecting a performance threshold.

4. The system of claim 3 wherein said performance threshold is selected from a group consisting of a condition index value threshold, a reliability index value threshold, a system failure threshold and a system reliability threshold.

5. The system of claim 1 wherein said Condition Database is comprised of component-types associated with condition index (CI) values, wherein said CI value is a value which reflects condition deterioration of said component-type at an identified time interval component-type

6. The system of claim 1 wherein said Reliability Database is comprised of component-types associated with reliability index (RI) values, herein said RI is a value which represents a probability said component-types will have a condition index value above a performance threshold.

7. The system of claim 1 wherein said Criticality Database is comprised of component-types associated with criticality values, wherein said criticality values reflect the probability of system failure if a component-type were to fail

8. The system of claim 7 wherein said criticality values mathematically represent the extent one entity which is mechanically dependent on another is affected.

9. The system of claim 1 wherein said Relationship Database includes data values which associate one component-type with another component-type.

10. The system of claim 1 wherein said Relationship Database includes data values which associate one system-type with another system type, one component-type with another component-type and one component-type with a system-type.

11. The system of claim 1 wherein said Predictive Model Processor is configured with processing components to graphically represent system reliability using a Bayesian Network approach.

12. The system of claim 1 wherein said Predictive Model Processor receives as input the condition index value and reliability index value for one of said component-types and calculates a system failure probability if one of said component-types were to fail.

13. A method for a creatinga predictive model of reliability, comprised of the steps of:
associating a plurality of component-types with condition index values and reliability index values to create a Reliability Database;
associating a criticality value with each of said plurality of component-types to create a Criticality Database;
identifying one or more relationships between said plurality of component-types and assigning a relationship value to each of said plurality of component-types; and
calculating system reliability associated with said plurality of component-types by extracting data from said Reliability Database and Criticality Database.

14. The method of claim 13 which further includes the step of populating a data structure from which a Bayesian Network diagram may be displayed

15. The method of claim 13 which further includes the step of calculating an adjusted system reliability based on the one or more relationships between said plurality of component-types and one or more system types.

16. The method of claim 13 which further includes the step of aggregating the Reliability Database based on the adjusted syste reliability.

17. A predictive modeling apparatus, comprised of:
a processor which receives a reliability index value, criticality value and relationship, values for a plurality of component-types;
a data structure for storing said plurality of component-types and their dependencies; and
a processor which creates a graphical model using said reliability index value, criticality value and relationship values for said plurality of component-types.

18. The predictive modeling apparatus of claim 17 wherein the graphical model is a system model.

19. The predictive modeling apparatus of claim 17 wherein the graphical model is based on a Bayesian Network approach.

20. The predictive modeling apparatus of claim 17 wherein the graphical model represents a system failure probability if one of said plurality of component-types were to fail.
